(19) United States
(12) Patent Application Publication
(10) Pub. No.: US 2013/0268664 A1
(43) Pub. Date: Oct. 10, 2013

(54) Method and Network Node for Providing Dynamic Subscriber Profiling Information

(71) Applicants: Mattias Lidström, Stockholm (SE); Jonas Björk, Stockholm (SE); Tor Kvernvik, Taby (SE); Mona Matti, Nacka (SE)

(72) Inventors: Mattias Lidström, Stockholm (SE); Jonas Björk, Stockholm (SE); Tor Kvernvik, Taby (SE); Mona Matti, Nacka (SE)

(73) Assignee: TELEFONAKTIEBOLAGET L M ERICSSON (PUBL), Stockholm (SE)

(21) Appl. No.: 13/993,337

(22) PCT Filed: Dec. 15, 2010
(86) PCT No.: PCT/SE2010/051384

§ 371 Date: Jun. 12, 2013

(51) Int. Cl. H04L 29/08

(52) U.S. Cl. CPC H04L 67/22
USPC 709/224

(57) ABSTRACT

In the embodiments of the present invention, a network node in an operator network is introduced. The network node is an analysis component configured to analyze the subscriber behavior based on the internet traffic data within the network. The network node is configured to provide a dynamic profile of the subscribers based on the current and past internet traffic. The dynamic profile may be used by other applications in the operator network or third parties. For example, a content provider can take a decision on what content to provide to a certain subscriber, based on dynamic subscriber profile information of this certain subscriber received from the network node according to the embodiments of the present invention. Another example is that an operator can use the dynamic subscriber profile when selecting commercial offers to his own subscribers e.g. when a subscriber has a new music mobile when visiting music sites.

### TECHNICAL FIELD

The embodiments of the present invention relate to an operator network node and a method thereof for enabling distribution of content, e.g. personalized content.

### BACKGROUND

Today internet traffic in mobile networks is increasing fast. The internet traffic can be analyzed to derive information about subscriber's internet behavior and dynamic subscriber profiles can be created. A challenge for the mobile networks operators is to efficiently analyze all this internet traffic information and leverage on the analysis results.

An example of how the analysis results can be used is transmission of content such as advertisements and other personalized content exemplified by mobile apps, games, ring tones, movies, music, etc. This is a growing area and has a huge potential to enable mobile operators to support advertisers and content providers of information such that the advertisers and content providers can personalize content and advertisements to the subscribers. In order to optimize the revenue for the advertisers and content providers, it is important to optimize the distribution of the content by sending each content to the subscribers that best fit the profile of the content and at a suitable time. This is referred to as dynamic subscriber profiling.

### SUMMARY

Thus, an object is to achieve a solution for providing dynamic subscriber profile information to be used for personalizing content transmission.

By using embodiments of the present invention it is possible to provide a dynamic subscriber profile based on a weighted accumulation of the subscriber historic and current internet traffic data considering recency and/or frequency and/or browsing duration of the visits to the different content category types. The dynamic subscriber profile characterises the content which a subscriber wants to consume. “Dynamic” implies that the subscriber profile is updated as content is consumed.

The trend analysis function provided by an embodiment is able to detect variations in the web browsing content category patterns e.g. that a subscriber is changing his normal browsing behaviour e.g. suddenly starting to browse pages related to music.

According to a first aspect of embodiments of the present invention a method in a network node in a communication network is provided. The communication network is controlled by an operator and is configured to carry internet traffic data. In the method, information of internet traffic data associated with subscribers within the communication network controlled by the operator is received and the received information is analysed. A dynamic subscriber profile is created or updated for a respective subscriber by using said analysis.

According to a second aspect of embodiments of the present invention a network node in a communication network is provided. The communication network is controlled by an operator and the communication network is configured to carry internet traffic data. The network node comprises an input section configured to receive information of internet traffic data associated with subscribers within the communication network controlled by the operator. The network node further comprises a processor configured to analyze the received information and to create or update a dynamic subscriber profile for the respective subscriber by using said analysis and a memory configured to store said dynamic subscriber profile.

An advantage with embodiments of the present invention is that an enhanced profiling of subscribers is provided. The enhanced profiling is based on the content types of the subscribers' internet traffic behaviour within the mobile network. The profiling information can be used by application to adapt applications according to the subscriber's interest. An example is to provide the users with the most appropriate advertisement at a given time and according to the subscriber's interest.

### BRIEF DESCRIPTION OF THE DRAWINGS

FIG. 1 illustrates the network node (Dynamic Subscriber Profiling Node DSPN) and its inter-working nodes according to embodiments of the present invention.

FIG. 2 illustrates schematically the network node according to embodiments of the present invention.

FIGS. 3-5 are flowcharts of the method according to embodiments of the present invention.

FIG. 6 illustrates a category tree to be used for embodiments of the present invention.

### DETAILED DESCRIPTION

Moreover, those skilled in the art will appreciate that the means and functions explained herein below may be implemented using software functioning in conjunction with a programmed microprocessor or general purpose computer, and/or using an application specific integrated circuit (ASIC). It will also be appreciated that while the current embodiments are primarily described in the form of methods and devices, the embodiments may also be embodied in a computer program product as well as a system comprising a computer processor and a memory coupled to the processor, wherein the memory is encoded with one or more programs that may perform the functions disclosed herein.

In the embodiments of the present invention, a network node in a communication network controlled by an operator is introduced. The network node is an analysis component configured to analyze the subscriber behaviour based on the internet traffic data within mobile and fixed network. The network node is configured to provide a dynamic profile of the subscribers based on the current and past internet traffic. The dynamic profile of the subscribers also referred to as dynamic subscriber profile may be used by other applications in the operator network or third parties. For example, a content provider can take a decision on what content to provide to a certain subscriber, based on the dynamic subscriber profile information of this subscriber received from the network node according to the embodiments of the present invention. Another example is that an operator can use the dynamic subscriber profile when selecting commercial offers to his own subscribers e.g. when a subscriber has a new music mobile when visiting music sites. Although personalized content is the main scenario, the embodiments of the present invention are also applicable to other scenarios. The other scenarios comprise scenarios when the surfing behaviour of the subscriber is used as input. The operator may also use this information as one parameter in general subscriber profiling. Further, examples of personalized content are applications, content, services and user profiling.

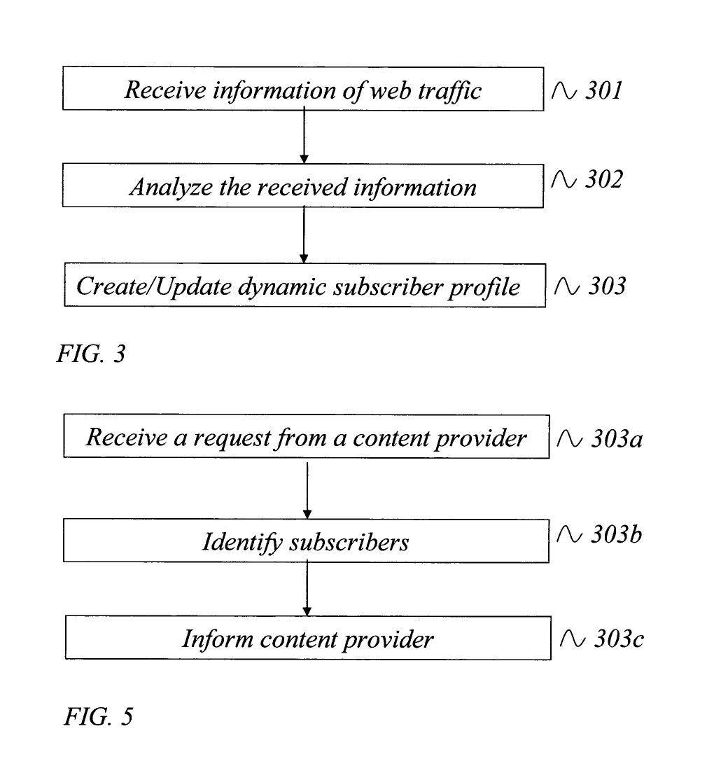

According to one aspect of the embodiments of the present invention a method in a network node in a communication network controlled by an operator is provided as illustrated in FIG. 3. The communication network is configured to carry internet traffic data. In the method, information of internet traffic data is received 301, wherein the internet traffic data is associated with subscribers of the operator within the communication network. The received information is analyzed 302 and a dynamic subscriber profile for the respective subscriber is created or updated 303 by using said analysis.

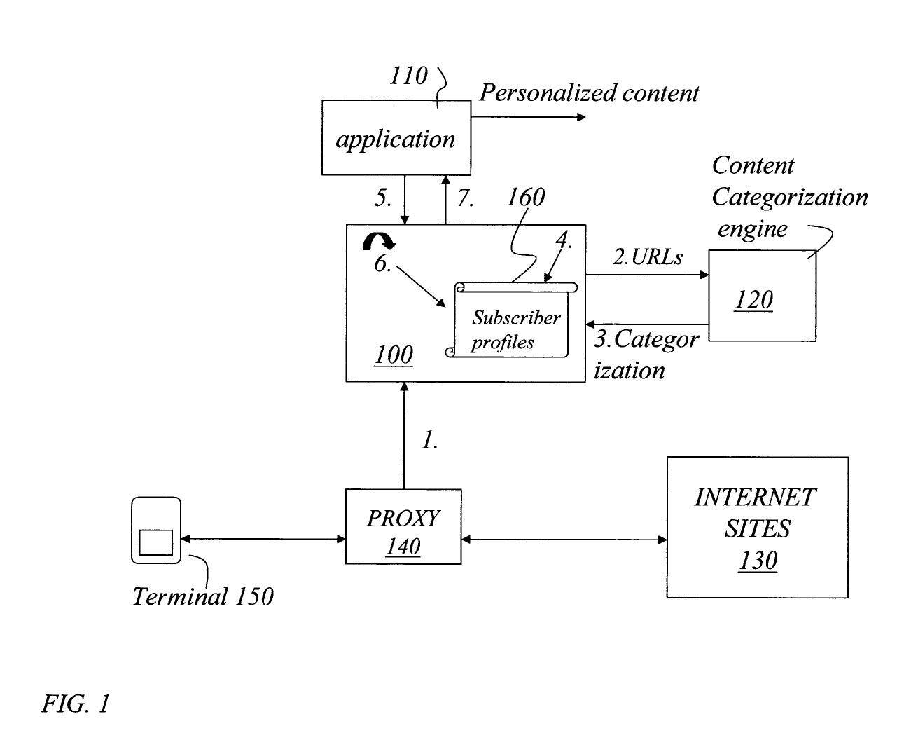

The network node is referred to as Dynamic Subscriber Profiling Node (DSPN) and interacts with other nodes. This is illustrated in FIG. 1. In the scenario of FIG. 1, the subscriber of a mobile terminal 150 is browsing content on the Internet 130. In one embodiment, a proxy server 140 within the telecommunication network monitors the internet traffic data sent to the subscriber and sends in step 1 information of the monitored internet traffic data to the network node 100. The internet traffic data may be HTTP traffic between the subscriber's mobile terminal and a content server. Thus, the proxy server 140 analyzes the HTTP traffic between the subscriber's mobile equipment and the internet and reports Uniform Resource Locators (URLs), including time stamp and duration, that the subscriber has browsed. In addition the proxy server may also provide subscriber identity such as Mobile Subscriber Integrated Services Digital Network Number (MSISDN) to the network node. A history log for each subscriber specifies the URLs that the subscriber has visited with time stamps.

However, any type of inspection functionality e.g. a Deep Packet Inspection engine (DPI) or a packet inspection functionality in a network node e.g. a gateway or a radio network controller may be used to obtain the same information as the proxy server.

Hence, the URLs of the monitored internet traffic data is sent in step 1 to the network node 100. The network node may then send in step 2 URL information to a content categorization engine (CCE) 120 and the CCE 120 is configured to categorize the URLs that the mobile terminal has visited. The result of the categorization is returned in step 3 to the network node and the dynamic subscriber profile is updated or created in step 4 accordingly. The network node comprises a memory 210 for storing these dynamic subscriber profiles 160. Hence, the network node 100 is configured to analyze the total stream of events derived from the subscribers HTTP traffic within the network.

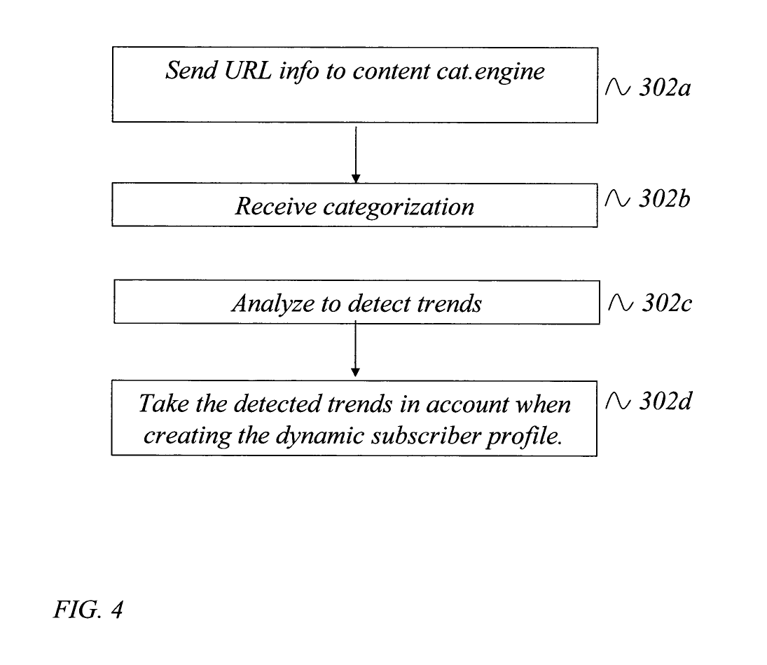

In accordance with embodiments of the present invention, a dynamic subscriber profile may be created or updated if there already exists a subscriber profile for this subscriber by the network node based on the type of browsing content. As illustrated in the flowchart of FIG. 4, the information of the internet traffic data is sent 302a to a content categorization engine, and a categorization of the internet traffic data for a certain subscriber is received 302b.

The dynamic subscriber profiles may be weighted which implies that a weight may be used to influence the subscriber profiles based on a number of parameters e.g. time, duration etc. The network node is able to dynamically inform other nodes, via different interfaces, about the current weighted profile of a subscriber derived from the kind of content the subscriber is consuming and has consumed.

According to a further embodiment, the network node is able to analyze 302c trends and to take 302d this analysis into account when creating the dynamic subscriber profiles as illustrated in the flowchart of FIG. 4. If a subscriber has recently changed browsing pattern, the network is able to detect this and inform other nodes about it. The network node may work both in pull and push mode. This means that other nodes can request information from the network node about subscribers' profiles fulfilling certain criteria's. Applications of the other nodes may comprise subscriptions Application Programming Interfaces (APIs), wherein the APIs are used by the applications to subscribe for subscriber profiling information. Referring again to FIG. 1 and FIG. 5, wherein the application 110 may be exemplified by an advertising engine which requests in step 5, 303a information of subscribers having a certain dynamic subscriber profile from the network node 100. The network node identifies in step 6,303b subscribers with that profile and informs in step 7,303c the application of those subscribers. The profiling information can then be used by the application to personalize the content to be transmitted. The attributes for the API may be used to define the constraints of the profiling.

Further the network node may comprise interfaces, referred to input and output sections, towards a content categorization engine, a proxy server and application nodes. The interface towards the categorization engine is used to send Uniform Resource Locators (URLs) and to receive categorization information, the interface towards the proxy server is used to receive URLs, including time stamp and duration, and the interface towards the application nodes is used to receive a request for subscriber profiling information and to send profiling information.

The received information of the internet traffic data associated with subscribers of the operator within the communication network comprises information of the URLs browsed during a period of time. According to an embodiment, the URLs browsed are detected by the proxy analyzing the internet traffic i.e. the interactions between the subscriber and the content servers. A number of attributes received from the content analyzer and by analyzing the web traffic is used as input when creating or updating the dynamic subscriber profiles.

The analysis of the received information of the internet traffic data associated with subscribers within the communication network controlled by the operator may comprise:

Determining categories and confidence values of all URLs browsed with time stamps.

Calculating recency values by e.g. sorting the interactions between the mobile terminal and the content providers according to the time stamps in a chronological order and weighting them on an exponentially decaying scale computed over their ordinal rank.

Detecting the browsing duration of a page is detected by analyzing the HTTP traffic i.e. the time between the HTTP messages indicating request for and reception of a webpage.

As explained above, the network node 100 also referred to DSPN is configured to analyse the HTTP traffic for each subscriber. The URLs are analyzed to detect what type of content the subscriber is currently and historically consuming. The DSPN may be equipped with or interworking with a content categorization engine 120 that supports the analysis of the URLs and map them to content types. The content categorization engine 120 classifies the URL with different methods. One classification method comprises analysis of the URL by analyzing text and checking the number of occasions certain words that are related to certain categories appears.

There are usually a number of predefined main content classes with subclasses. An example of a main class is sport and the corresponding subclasses football, basket, all sports etc.

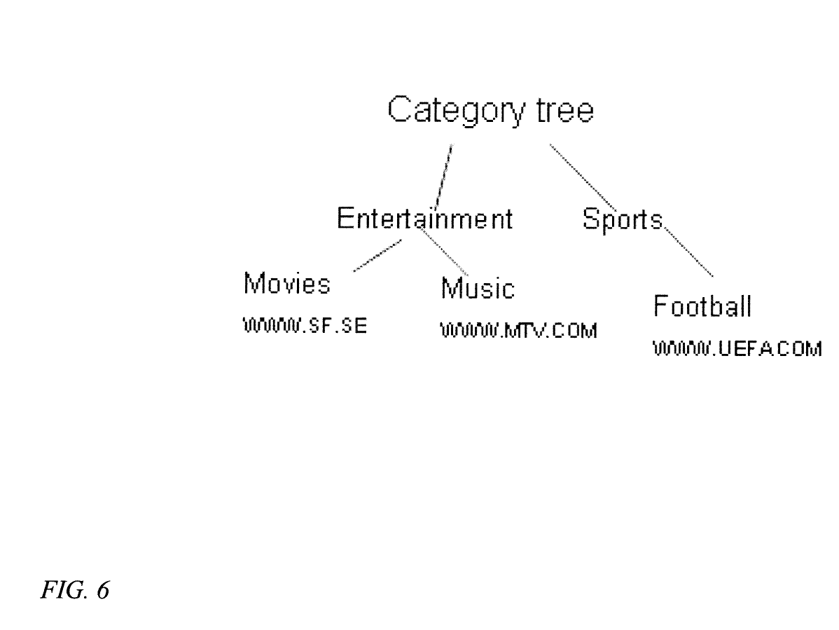

An example of a category tree is shown in FIG. 6.

The content categorization engine 120 responds with a number of categories for each URL in a descending order that best fits the content that is reached by the URL. One URL usually corresponds to several categories. The different categories that match the URL are marked with confidence values. The confidence value corresponds to the probability that the content of a certain URL belong to a certain category.

Example: URL=newspaper XYZ may generate the following response with the main/sub class marked. The confidence value is usually normalized between 0 and 1.

| Categories | Confidence |
|---|---|
| Personal/Health | 0.045 |
| Entertainment/Arts & Culture | 0.029 |
| Sports/All Sports | 0.019 |
| Personal/Religion & Belief | 0.017 |
| Personal/Family | 0.011 |

According to an embodiment of the present invention, the DSPN comprises a memory 210 for temporarily storing all received categories and confidence values in a vector database per subscriber. The stored categories and confidence values may be deleted when they are no longer interesting to be used in the calculation, e.g. after a predetermined time.

The subscriber profile analysis is performed to get one accumulated weighted value for the subscriber's profile. The profile may be weighted based on the following criteria's:

Confidence & Categories: The categories of the web pages and the confidence values are used as a weight to decide the order of the impact of the subscriber profile. A category with high confidence has a stronger impact on the accumulated category.

Frequency: URLs visited more frequently gives more impact to the subscriber profile.

Recency: The more recently visited URLs are weighted higher. Weights decay exponentially over time with the half-life as a configurable parameter. This means that a browsing for a certain content that occurred in the current time has a contribution of 1 to whereas an interaction from a browsing that occurred one half-life ago contributes ½ and so on.
WBevents (Web Browsing events) is the sum of the Web Browsing (WB) events.
tnow is the current time
t(i) is the time stamp of the web browsing event.
λ is the time when the impact is decayed to 50%.
The equation to estimate recency is
WBevents=Σ(1/2)^{(tnow-t(i)))/λ}

Below is a table with an example of the impact of the profile for an example subscriber from two browsing events. The categories and confidence values for two different browsing sessions i.e. URLs with the prediction decay included.

The half time(λ) is set to 30 hours.

The URL xyz was accessed 5 hours ago. This means that the decay factor due to aging is 0.5^{(5/30)}=0.89

| Category | Confidence | Confidence with decay factor |
|---|---|---|
| Personal/Health | 0.045 | 0.040 |
| Entertainment/Arts & | 0.02 | 0.026 |
| Culture | | |
| Sports/All Sports | 0.019 | 0.017 |

URL=abc, the URL was accessed 50 hours ago. This means that the decay factor due to aging (recency) is 0.5^{(50/30)}=0.31

| Category | Confidence | Confidence with decay factor |
|---|---|---|
| Sports/All Sports | 0.091 | 0.028 |
| Personal/Religion & Belief | 0.042 | 0.013 |
| Personal/Family | 0.038 | 0.012 |

The aggregated category and confidence values (which are the sum of the Confidence with decay factors) for the example subscriber from the two browsing events is then:

| Category | Aggregated confidence |
|---|---|
| Sports/All Sports | 0.045 |
| Personal/Health | 0.040 |
| Entertainment/Arts & Culture | 0.026 |
| Personal/Religion & Belief | 0.013 |
| Personal/Family | 0.012 |

The table shows that the impact of the browsing to the dynamic subscriber profile of the example subscriber is more impacted from the more recent browsing events.

As an additional weight factor, the browsing duration may be used. A longer duration of the visit to a web page may indicate a higher interest in the content category.

The duration of the visit to a certain content (e.g. web page) is possible to detect from e.g. the proxy server by analyzing the web traffic. The duration of each browsing session is detected by e.g. the proxy server and sent to the DSPN for each browsing session.

The algorithm to be used should give a weight between 0.5 for very short durations and 1 for longer durations.

A modified sigmoid function may be used to get the requested output.
Y=1/(1+exp(−k×x))
k=0.5
y=the weight 0.5<1.0
x=duration (minutes)

If for example the duration of the session to URL xyz x was 1 minute the weight factor y is 0.6. It should be noted that also a very short browsing session will get at least 0.5 weight.

In some cases it is more important to detect patterns in the behavior and sudden changes in the patterns than the accumulated weighted value. One example could be a subscriber called Bob who very seldom browses pages with content related to entertainment/music but suddenly starts to heavily browse pages related to entertainment/music. Another subscriber called Bill may have a more constant rate or decreasing rate of browsing content related to entertainment/music. This information could be interesting for a directed marketing campaign for music i.e. Bob may be regarded as an inexperienced music consumer and Bill as a more experienced consumer and should thereby get different offers.

Accordingly, the DSPN may comprise a trend analyzer 220. The trend analyzer 220 may be configured from an external node via an API. Examples of attributes to be used for the trend analyzer are content Category, Increasing/decreasing, and speed=moderate/medium/high.

Several categories may be traced simultaneously e.g. multiple categories per marketing campaign. An example may be an advertising campaign for music with different offers depending on experience level of the listener. The advertisement provider may provide the following trend analysis request targeting the inexperienced with the following parameters: Category=(entertainment/music), direction=increasing, speed=high.

The algorithm used to detect the trends may compare the weighted moving mean value for a short period with weighted moving average for a longer period. The values from the weighted recency algorithm as described above may be used to estimate a moving weighted average for the classification of the subscriber. A configurable parameter called “classification deviation” is used to define thresholds for the different levels. Examples of the “classification deviation” parameter follow:

ClassDevModerate=the minimal deviation that is required to classify the subscribers as Moderate increase/decrease. E.g. 20%

ClassDevMedium=the minimal deviation that is required to classify the subscribers as Medium increase/decrease. E.g. 35%

ClassDevHigh=the minimal deviation that is required to classify the subscribers as High increase/decrease. E.g. 50%

The recency algorithm described above is used to estimate a Weighted Moving Average (WMA) for the period.

E.g. a subscriber called David has been browsing more on web pages related to sports the last week than normally e.g. during last year. The WBeventShort for sport is 0.456 and WBeventsLong for sport is 0.280. This means that the deviation is +62% and is classified as a high deviation (CLassDevHigh).

An example of equation to be used for estimating the short term deviation is Deviation=(WBeventsShort−WBeventLong)/WBeventLong

Embodiments of the present invention are described by the following example of an advertisement campaign to subscribers.

An advertisement engine is going to launch an advertisement for sports gear for a sport retailer. The target group for the advertisement is persons with an interest in sport.

Referring again to FIG. 1 to illustrate this example, in the first step 1, the proxy server continuously monitors the HTTP traffic between the subscribers and the internet. The proxy server 140 sends subscriber identity, URL information, time stamp, and duration to the DSPN associated with the monitored HTTP traffic for each session. The DSPN receives this information via an input unit.

In step 2, the DSPN forwards the URL information to the content categorization engine and requests a categorization of the URL. The content categorization engine returns a content categorization in step 3. The received content categorization of the URL is used to create or update the dynamic subscriber profiles for the concerned subscribers.

Accordingly, these steps 1-4 are performed continuously to keep an updated profile of all subscribers.

In step 5, an advertisement engine or another engine that distributes personalized content requests dynamic subscriber profile information to be able to distribute content to a certain group of subscribers. In this example, the advertisement engine requests a profiling of subscribers with interest in sport and health. The profiling request sent may contain the following attributes:

Profile(Sport/all sports, Personal/health)

In step 6, the DSPN analyzes the request, identifies the subscribers having the requested profile and sends 7 the requested subscriber information to the advertisement engine or another engine configured to distribute personalized content. In the advertisement scenario, steps 5-7 are performed for each new campaign.

In this example, the advertisement engine distributes the advertisement to the identified subscribers.

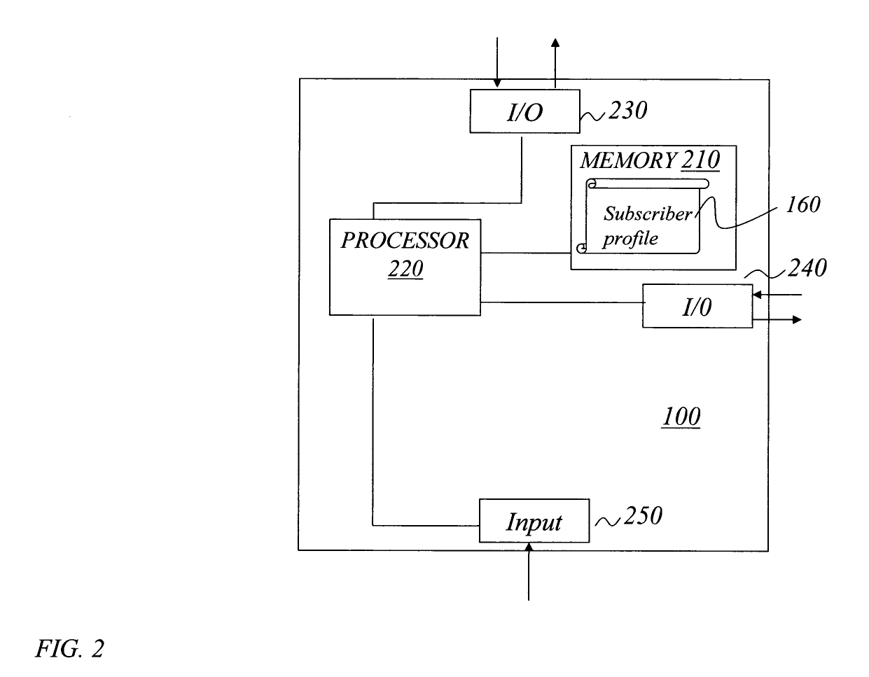

With reference to FIG. 2, the embodiments of the present invention relate to a network node 100, also referred to as DSPN, in a communication network controlled by an operator. The communication network is configured to carry internet traffic data. The network node 100 comprises an input section 250 configured to receive information of internet traffic data associated with subscribers within the communication network controlled by the operator, a processor 220 configured to analyze the received information, and to create or update the dynamic subscriber profile for a respective subscriber by using said analysis. Further as illustrated in FIG. 2, the dynamic subscriber profiles (160) may be stored in the memory 210.

According to embodiments, the network node 100 comprises a first input/output section 240 configured to send the information of the internet traffic data to a content categorization engine, and to receive a categorization of the internet traffic data for a certain subscriber.

Moreover, the processor 220 may further be configured to analyze the received internet traffic data to detect trends associated with behaviour of the respective subscriber, and to take the detected trends in account when creating the dynamic subscriber profile.

In addition, the network node 100 may further comprise a second input/output section 230 configured to receive a request from a content provider to identify subscribers with a certain dynamic subscriber profile. In this embodiment, the processor 220 is configured to identify subscribers with the certain dynamic subscriber profile, and the second input/output section 230 is configured to inform the content provider of the identified subscribers.

The input and output sections may be interfaces such as APIs.

Modifications and other embodiments of the disclosed invention will come to mind to one skilled in the art having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of this disclosure. Although specific terms may be employed herein, they are used in a generic and descriptive sense only and not for purposes of limitation.

1-11. (canceled)

12. A method in a network node in a communication network controlled by an operator, wherein the communication network is configured to carry internet traffic data, and wherein the method comprises:
receiving information of internet traffic data associated with subscribers within the communication network;
analyzing the received information;
creating or updating a dynamic subscriber profile for a respective one of the subscribers by using said analysis of the received information;
sending the received information to a content categorization engine, and receiving a categorization of the internet traffic data for the respective subscriber;
analyzing the received categorization to detect trends associated with the behavior of the respective subscriber; and
taking the detected trends in account when creating the dynamic subscriber profile for the respective subscriber.

13. The method according to claim 12, wherein the received information is received from a proxy server in the communication network.

14. The method according to claim 12, wherein the received information comprises at least one of internet traffic data categories, frequency of visits for one or more Uniform Resource Locators (URLs), and browsing durations, for respective ones of the subscribers.

15. The method according to claim 12, further comprising:
receiving a request from a content provider to identify subscribers with a certain dynamic subscriber profile;
identifying subscribers with the certain dynamic subscriber profile; and
informing the content provider of the identified subscribers.

16. The method according to claim 12, wherein at least one parameter of the dynamic subscriber profile is weighted, wherein the weight is derived from a type of content the respective subscriber is consuming and has consumed, and a duration and time of said consumption.

17. A network node in a communication network controlled by an operator, wherein the communication network is configured to carry internet traffic data, and wherein the network node comprises:
an input section configured to receive information of internet traffic data associated with subscribers within the communication network;
a processor configured to:
analyze the received information, and
create or update a dynamic subscriber profile for a respective one of the subscribers by using said analysis of the received information; and
a memory configured to store the dynamic subscriber profile;
a first input/output section configured to:
send the received information to a content categorization engine, and receive a categorization of the internet traffic data for the respective subscriber; and
wherein the processor is further configured to:
analyze the received categorization to detect trends associated with the behavior of the respective subscriber, and
take the detected trends in account when creating the dynamic subscriber profile for the respective subscriber.

18. The network node according to claim 17, wherein the received information is received from a proxy server in the communication network.

19. The network node according to claim 17, wherein the received information comprises at least one of internet traffic data categories, frequency of visits for one or more Uniform Resource Locators (URLs), and browsing durations, for respective ones of the subscribers.

20. The network node according to claim 17, further comprising a second input/output section configured to receive a request from a content provider to identify subscribers with a certain dynamic subscriber profile, and wherein the processor is configured to identify subscribers with the certain dynamic subscriber profile, and the second input/output section is configured to inform the content provider of the identified subscribers.

21. The network node according to claim 17, wherein at least one parameter of the dynamic subscriber profile is weighted, wherein the weight is derived from a type of content of the respective subscriber is consuming and has consumed, and a duration and time of said consumption.
